(19) United States
(12) Patent Application Publication
(10) Pub. No.: US 2004/0063588 A1
(43) Pub. Date: Apr. 1, 2004

(54) Delivery system for drilling fluid dispersible additive tablet and associated methods

(75) Inventors: Ronald Albert Rose, Alto, TX (US); Harvey M. Oyler III, Baytown, TX (US); Howard G. Ezell, Lafayette, LA (US)

Correspondence Address: Constance Gall Rhebergen, P.O. Box 61389, Houston, TX, 77208-1389, US

(73) Assignee: Grinding & Sizing Co., Inc.

(21) Appl. No.: 10/261,016

(22) Filed: Sep. 30, 2002

(51) Int. Cl. C09K 7/06

(52) U.S. Cl. 507/103

(57) ABSTRACT

A delivery system for delivering drilling fluid additives to a drilling fluid. According to one aspect of the invention, the delivery system comprises a softened, dispersible tablet containing drilling fluid additives, such as lost circulation, seepage control materials, and/or other additive materials. The tablet is preferably prepared by adding a softening agent or softening binder to the drilling fluid additive that will allow the tablet to disperse and revert, or break down, to release the drilling fluid additives in their original particle size into drilling fluids. It is also advantageous for the tablets to be dispersed top-side to ensure that the materials do not, for example, clog screens or damage downhole equipment.

### BACKGROUND OF THE INVENTION

1. Field of the Invention

The invention relates to a physical system for delivering drilling fluid additives and chemicals to drilling fluid during drilling operations. In particular, the system includes delivery of the additive in a compressed, encapsulated form as a tablet. The additive tablet is dispersible in the appropriate oil or synthetic-based or water-based drilling fluids. An exemplary use of the additive delivered in this fashion is to assist in controlling properties, such as lost circulation, seepage, fluid loss, viscosity, lubricity, foaming, shale, and pH during drilling operations.

2. Description of the Prior Art

Various drilling fluid additives are known in the art. Their uses include lost circulation additives, fluid loss additives, seepage loss additives, viscosifiers, thinners, shale control agents, weighting agents, lubricants, cleaning agents, flocculants, dispersants, anti-foaming agents, buffering or pH control agents and other uses. Some additives perform more than one of these functions or other functions useful in drilling activities.

The types of additives used for these purposes include organic products, mineral products and polymers, and are often delivered into the drilling fluid, or drilling mud, as a powder. The powder is typically fed through a hopper. There are numerous disadvantages to the use of powder. A primary disadvantage is that the additive can be very light causing it to flow slowly from the hopper and mix slowly with the highly viscous drilling fluid. In drilling operations, speedy incorporation of the additives into the mud and circulation down through the hole is highly advantageous and affects the profitability and occasionally the safety of the operation. To overcome the disadvantage of slow incorporation, hoppers have been designed with structures such as cyclones, venturis and jets to enhance mixing and to attempt to pull the additives from the hopper into the fluid at a higher rate. Mixing can be still relatively slow, even using these structures. Flow through the cyclones can be slow, clogging may occur, and dust may become a problem.

The mixing rate of powder is also dependent upon the type of drilling fluid being used, as well as the overall volume to be treated. There is a trend toward drilling in deeper water with bigger rigs, thus requiring larger volumes of mud and increased weights of mud. Thus, the muds being used tend to be more expensive muds and synthetic oils utilizing high quantities of weighting material. Use of the more expensive muds and synthetic oils also emphasizes the need for additives that control lost circulation and seepage. These factors create a need for larger volumes of additives for various purposes. However, storage space, particularly on an offshore rig, is a limiting factor. Moreover, current drilling operations utilizing lost circulation and seepage control additives generally require that the additive be delivered such that the additive is fully incorporated topside before leaving the mud pit. This criterion is particularly important as any lumps in the mud or fluid going downhole may damage expensive downhole tools, or may plug screens resulting in an unscheduled withdrawal of the drill string.

A need exists for a delivery system that allows operators to quickly introduce additives that will disperse, or break down, such that the additives within the fluid become small enough particles that they will not plug screens or damage expensive drilling equipment, but will still maintain their ability to perform their intended function within a well bore. There is a further need for a system that minimizes space requirement on the rig for storage. It would be advantageous for the delivery system to be tailored to work in synthetic-based or oil-based drilling fluids. It would also be advantageous to provide a similar delivery system providing these same advantages for water-based drilling fluids. There is a need for a low or no-dust alternative for delivery of the additives to the drilling fluid. There is a need for an additive delivery system that quickly and efficiently distributes additives into the drilling fluid upon introduction.

### BRIEF SUMMARY OF THE INVENTION

In order to meet one or more of the needs in the art such as those identified above, the present invention advantageously provides a delivery system for drilling fluid additives. According to one aspect of the invention, the delivery system includes a softened, dispersible tablet containing drilling fluid additives. The drilling fluid additive tablet is preferably prepared by adding a softening agent or softening binder to the drilling fluid additive that will allow the tablet to disperse and revert, or break down, to release the drilling fluid additive in its original particle size into drilling fluids. The drilling fluid transports the drilling fluid additive to within the drilling fluid. It is also advantageous for the tablets to be dispersed top-side to ensure that the materials do not, for example, clog screens or damage downhole equipment.

A technical advantage of the present invention is that the delivery system provides dispersed material downhole small enough to pass through screens and avoid damage to any of the drilling equipment. It is important for the dispersion to be substantially complete to ensure that no non-dispersed particles remain, since the larger particles can plug up screens and damage equipment within the well bore. Screens are used in various places within a well bore, such as upstream of a directional motor, a Logging-While-Drilling tool, or a Measurements-While-Drilling tool. Screens are typically used upstream of sensitive tools to protect the tools from large particles within the drilling fluid. If screens become plugged, the equipment may be damaged, and the drill pipe may have to be pulled up in order to clean the screens.

In the inventive delivery system, a softening agent is advantageously added to the drilling fluid additives and mixed thoroughly, preferably in a ribbon blender, prior to formation into a soft tablet. In at least one embodiment, the resulting soft dispersible tablet typically has a composition of about 5% to about 15% of the softening agent.

Softening agents (also known as wetting agents) are known in the art. Embodiments of the present delivery system incorporate softening agents or wetting agents to facilitate the mixing of dry powders into the mud, in a manner that allows the tablet to break down and release the desired additive. In such embodiments, the softening agents assist creation of a “soft tablet” by keeping the tablet from getting hard.

The softening agents can be used in water-based drilling fluids and oil-based or synthetic-based drilling fluids. Selection of a specific softening agent depends upon the drilling fluid system for which the tablet is intended, e.g., oil versus water based fluids.

If the drilling fluid to be used is water-based, then the specific softening agent can be selected from at least one of the following compounds: ethylene oxide adducts of phenol and nonyl phenol, a mixture of ethylene glycol and propylene glycol, high molecular weight water soluble polyethylene glycols, modified water dispersible lecithins, and the like. Centromix E sold by Central Soya Company is a presently preferred commercially available modified water dispersible lecithin.

If the drilling fluid to be used is a synthetic or diesel based fluid, then the specific softening agent can be selected from at least one of the following compounds: sodium dodecyl benzene sulfonate, fatty acid amides and imidazolines of polyamines, and phospholipids, such as lecithin. Driltreat® provided by Baroid Technology Inc. and Novawet® by NovaChem and distributed by M-I LLC are two presently preferred commercially available agents.

Various additives are known for use in drilling fluid operations as viscosifiers, thinners, weighting agents, lubricating agents, shale control agents, anti-foaming agents, buffering agents, flocculants, dispersants and the like. The delivery system of the present invention includes soft tablets for dispersing lost circulation materials in synthetic or oil-based and water-based fluids. Likewise, seepage control materials can be delivered by this system. Similarly, various additives, such as those listed above, that are to be immediately dispersed within the drilling fluid can be added using this delivery system. One or more of the lost circulation material, seepage control material or additives can be delivered through this system. The term drilling fluid additives, as used in this disclosure, includes (but is not limited to) lost circulation material, seepage control material and each of these various additives are within the scope of the present invention. Viscosifiers, thinners, weighting agents, lubricating agents, shale control agents, anti-foaming agents, buffering agents, flocculants, dispersants are referred to as additives or components, as opposed to lost circulation or seepage control materials, or softening agents. These additives or components are also within the scope of the present invention.

In other embodiments, the soft dispersible tablets comprised in the inventive delivery system include the softening agent and drilling fluid additives formed into a tablet by compression. The drilling fluid additives can be any material used to prevent lost circulation or seepage of the drilling fluid. Suitable drilling fluid additives will be known to those skilled in the art and are to be considered within the scope of the present invention in general form. Lost circulation materials useful in this invention are chemically untreated or “raw.” Heating, steaming or grinding would not and are not to be considered to be chemical treatments. The soft tablet delivery system, while characterized by its ability to disperse in the appropriate drilling fluid, also shows markedly increased density.

A further technical advantage of the inventive delivery system is that the soft tablet included in embodiments thereof shows increased density. Presently preferred embodiments include a soft tablet with dimensions in a range of ⅛ inch to ¾ inch for diameter and a range of ⅛ inch to 1 inch for length. The density of the additive compressed into the delivery system ranges widely according to the base material, with the preferred density being the highest ratio of compression achievable based on the characteristics of the material. A substantial increase in density is a non-trivial increase as compared to the density of the raw materials used to create the denser tablet. It is known that many organic materials can be compressed to between two and three times the density of the ground material.

The present invention also advantageously includes a method of delivering a drilling fluid additive to a drilling fluid. In this embodiment, drilling fluid additives are supplied or prepared and then the materials are mixed with the softening agent. Any type of mixer can be used to mix the materials, such as a ribbon blender. Once the materials are mixed, the materials are compressed to form the soft dispersible tablet. In use, the soft dispersible tablet is dispersed into the drilling fluid, which breaks down, or reverts, the drilling fluid additive back into the original particle size distribution prior to placement of the drilling fluid additive in the drilling fluid. The reversion of the drilling fluid additive into the original particle size distribution may be done topside or down hole. The original particle size distribution is based upon the size of the particles forming the lost circulation material prior to being mixed with the softening agent.

The structure and method of the present invention as well as other features, advantages, benefits and objects thereof over other structures and methods known in the art can be better understood with reference to the detailed description, which follows.

### DETAILED DESCRIPTION OF THE INVENTION

Certain compressed drilling fluid additives used experimentally evidenced difficulty in dispersion. This invention addresses that difficulty by delivering additives in a softened tablet that disperses specifically in a target drilling fluid. The present invention advantageously includes a delivery system for controlling functions, such as lost circulation, seepage, fluid loss, viscosity, lubricity, foaming, shale, and pH in drilling operations. The delivery system preferably includes the soft dispersible tablet, which includes drilling fluid additives and a softening agent. In use, the soft dispersible tablet is deployed within a drilling fluid for carrying the drilling fluid additives to a zone of lost circulation or the like. When the soft dispersible tablet is deployed within the drilling fluid, the drilling fluid advantageously disperses the soft dispersible tablet quickly, allowing delivery of the drilling fluid additives. The drilling fluid transports the drilling fluid additive to within the drilling fluid. The current invention includes a soft tablet to maximize the rate of incorporation of contained additive into the drilling fluid.

In preferred embodiments of the present invention, the soft dispersible tablet contains around 85% to around 95% of drilling fluid additives and around 5% to around 15% of the softening agent delivered in the readily-dispersible system in the form of the soft tablet. The tablet is advantageously deformable due to being soft.

Water-based drilling fluids, or drilling muds, are generally understood as those in which water or saltwater is the major liquid phase as well as the wetting (external) phase. General categories of water-based drilling fluids are freshwater, seawater, salt water, lime, potassium and silicate. If the drilling fluid to be used is water-based, then the softening agent for use in the inventive delivery system can be selected from the following compounds: ethylene oxide adducts of phenol and nonyl phenol, a mixture of ethylene glycol and propylene glycol, high molecular weight water soluble polyethylene glycols, modified water dispersible lecithins, and the like.

Synthetic-based drilling fluids are known to come in a broad range. Popular fluid types include several olefin oligomers of ethylene. Esters made from vegetable fatty acid and alcohol were among the first of such type of fluids. Ethers and polyethers, made from alcohols and polyalcohols, have been used, along with paraffinic hydrocarbons and linear alkyl benzenes. Mixtures of these fluids are also used to make synthetic-based drilling fluids. Other examples will be known to those skilled in the art.

An oil-based mud is a type of drilling mud with diesel oil as its external phase. Diesel-oil mud is the traditional oil mud and has a history of excellent performance for drilling difficult wells. It has been used because the base oil is low-cost and is a widely available motor fuel. In-gauge holes can be drilled through all types of shales, salt, gypsum and other difficult strata using diesel-oil mud systems. Diesel-oil mud is often the mud of choice for drilling high-pressure, high-temperature zones.

If the drilling fluid to be used is a synthetic or oil based fluid, then the specific softening agent can be selected from at least one of the following compounds: sodium dodecyl benzene sulfonate, fatty acid amides and imidazolines of polyamines, and phospholipids, such as lecithin.

The additives useful for the present invention are standard or industry-acceptable materials that perform various functions in the drilling fluid, such as lost circulation and seepage control, fluid loss, viscosity, lubricity, foaming shale, and pH control. As such, the additives are typically standard materials recognized by one of ordinary skill in the art for use in drilling fluid.

The tablet can deliver one or more additives, the delivery being triggered by the injection of the soft tablet into the target drilling fluid. Among the inorganic materials useful in this invention, mineral components are readily available, such as calcium carbonate, mica, diatomaceous earth, Fuller's earth and other silicates, activated charcoal, bauxite, alumina gel, graphite, gilsonite and the like. Such materials are frequently provided in fiber or ground form. Carbonate can be used alone or in combination with other desirable additives. The effect of adding carbonate to organic additives is an improved acid solubility. This also results in a tablet of increased density. Also useful are plastics such as thermosets, thermoplastics and rubber compounds including melamine, polyvinylchloride (PVC) and cellophane. These plastics can be ground into granules or powders.

Other materials to be delivered to the system useful for managing the rheological characteristics of drilling fluid include the rheological additives of lignites containing calcium hydroxide, leonardite, leonardite with potassium, leonardite with gyp, organophilic leonardite, lignin-based powders, bitumens. Also useful are lignosulfonates, including those with chrome or chrome-free, and those containing calcium, iron, tin, zinc and other heavy metals. Asphalt and various forms of asphalts are included in as rheological additives, including sodium sulfonate asphalt and potassium sulfonate asphalt. Rheological additives also include various clays including organophilic clays, attapulgite clays, montmorillonite clays, kaolinite clays and calcined clays. Polyacrylate powders, polyacrylamide homopolymers and copolymers, polyanionic cellulose, cellulosic polymers and the like are also rheological additives useful in the invention. Xantham gums, metal silicates, starches (including corn), sugarbeet, wood and potato starches, and guar gum are included. Fatty acids, including tall, refined, unrefined, and polyaminated are also rheological additives. Other rheological additives include amphoterics such as aluminum salts and the like, carboxymethyl cellulose, sodium carboxymethyl cellulose, welan gum, hydrocarbon resins, hydroxyethylcellulose, and polyphosphate. Other drilling fluid additives can include barium sulfate, hematite, sodium chloride, calcium chloride, potassium chloride, bromides, sodium, calcium, zinc, gilsonite, graphite, petroleum coke and calcine coke. Fibrous insulation material such as Rockwool insulation can be used as Theological additives.

The present invention also advantageously includes a method of delivering a drilling fluid additive to a drilling fluid. In this embodiment of the present invention, drilling fluid additives are supplied or prepared and then the drilling fluid additivies are mixed with the softening agent. Any type of mixer can be used that can adequately mix the materials. An example of such a blender is a ribbon blender. Once the materials are mixed, the materials are formed into the soft dispersible tablet. The soft dispersible tablet is dispersed into the drilling fluid, which breaks down, or reverts, the drilling fluid additive back into the original particle size distribution prior to placement of the drilling fluid additive in the drilling fluid. The original particle size distribution will be understood to be based upon the size of the particles forming the drilling fluid additive prior to being mixed with the softening agent. The reversion of the drilling fluid additive into the original particle size distribution can occur downhole, or more preferably topside. Topside refers to the portion of the well bore prior to the drill string. From the mud pit to the drill string is typically considered to be topside.

The softening agent assists tablets included in the inventive delivery system to disperse in various types of drilling fluids, including oil-based and synthetic-based drilling fluids. Initial trials with pelletized lost circulation materials generally did not utilize wetting agents, surfactants, or emulsifiers. When these trials were made in hydrocarbon fluids, such as diesel, mineral oil, and low aromatic content alpha olefins as used in many offshore drilling applications or other hostile environments, it was noted that dispersion rate was difficult to predict. It is believed that, since most of the lost circulation materials are produced from natural fibers and granules, these materials are more hydrophilic than oleophilic making dispersion in hydrocarbon fluids less rapid. The present invention advantageously provides rapid dispersion in hydrocarbon fluids through the use of the soft tablet.

Similarly, wetting agents, surfactants, and emulsifiers aid in the dispersion of the soft tablets in water based fluids. The softening agent of the present invention prevents plugging of well pumps, drill pipe, drill bits, and screens since all of the tablet material is dispersed, leaving no materials that are not dispersed. The particles are small enough to pass through the screens and machinery without damaging them. The use of the proper wetting agent, surfactant, and emulsifier, such as the softening agent, prevents any degradation of the drilling fluid, particularly emulsion stability or viscosity.

In one embodiment of the present invention, high concentration slurries of dispersed tablet material can be prepared in the “slugging pit” prior to pumping downhole to the affected zone. As another advantage of the present invention, the inventive delivery system delivers lost circulation materials that disperse in oil and/or water based drilling fluids, thereby avoiding reliance on mechanical energy to disperse the tablets throughout the drilling fluids. The present invention's provision of hydrodynamic or oleodynamic dispersion of the tablet rather than mechanically-aided dispersion avoids high cost mechanical dispersion equipment and extensive mixing time at the rig site. Dispersion is generally understood as the act of breaking up large particles into smaller ones and distributing them throughout a liquid or gaseous medium. Dispersion is conventionally accomplished by various methods depending upon the type of drilling fluid that is used in an application. In a water-base drilling mud application, dispersion is generally the act of degrading clay materials, starches, carboxymethylcellulose, biopolymer, synthetic polymers or oils into submicroscopic particles. In oil-mud emulsion terminology, dispersion is generally the act of forming a fine-grained emulsion of an aqueous phase into an oil. This is conventionally accomplished by mechanical shearing or heating in the presence of surfactants. As previously described, the present invention's dynamic dispersion feature eliminates the need for the equipment necessary to mechanically disperse the lost circulation materials within the drilling fluids.

The inventive delivery system further includes breaking down the additives into their original particle size distribution, which tends towards effective use of the materials. As noted, if the materials do not revert to their original particle size distribution during dispersal, their effectiveness in eliminating loss of fluids in the well bore is reduced. Conventionally, the original particle size distribution is typically optimized by the manufacturer prior to tabletization. This tabletization process compresses and densifies the materials, which, without more, can reduce the effectiveness of the materials to return to their original particle size distribution during dispersal. The present invention avoids such disadvantages.

The present invention is particularly effective at delivering cellulostic lost circulation and seepage control materials, although the invention is not limited in this regard. In particular, the invention is particularly effective at delivering one or more of the following cellulostic materials, alone or in combination: ground wood, pine bark, fruit pomace, vegetable pomace, yellow pine, pine bark, corn cobs, peanut hulls, pecan piths, almond shell, corn cob outers, bees wings, cotton burrs, oat hulls, rice hulls, seed shells, sunflower, flax, linseed, cocoa bean, feathers, peat moss, jute, flax, mohair, wool, sugar cane, bagasse, sawdust, bamboo, cork, popcorn, tapioca, and grain sorghum.

The invention is also effective at delivering inorganic lost circulation and seepage control materials, although the invention is again not limited in this regard. Such inorganic materials include mineral components that are readily available, such as calcium carbonate, mica, diatomaceous earth, Fuller's earth and other silicates, activated charcoal, bauxite, alumina gel, graphite, gilsonite and the like. Such inorganic materials are frequently provided in fiber or ground form. Carbonate can be used alone or in combination with other desirable additives. The effect of adding carbonate to organic additives is known to improve acid solubility. This also results in a tablet of increased density. The inventive system can also deliver plastics such as thermosets, thermoplastics and rubber compounds including melamine, polyvinylchloride (PVC) and cellophane. These plastics can be ground into granules or powders.

Another advantage of use of the inventive softened dispersible tablet is the reduction of dust during addition to the drilling fluid. Traditional powders added through a hopper create volumes of dust that create a hazard to the environment and to the working personnel. Certain areas, such as the North Sea, have stringent regulations on dust. The use of the inventive delivery system reduces the creation of dust substantially.

From the foregoing it will be seen that this invention is one well adapted to attain all of the ends and objects hereinabove set forth, together with other advantages that are obvious and that are inherent to the apparatus and structure.

It will be understood that certain features and subcombinations are of utility and can be employed without reference to other features and subcombinations. This is contemplated by and is within the scope of the claims.

Because many possible embodiments can be made of the invention without departing from the scope thereof, it is to be understood that all matter herein set forth is to be interpreted as illustrative and not in a limiting sense. For example, without limitation, the soft dispersible tablets can also include insecticides, biocides or other biological operatives to reduce susceptibility to various types of degradation or to repel pests.

What is claimed is:

1. A delivery system for controlling the release of drilling fluid additives in drilling operations, the delivery system comprising:
a soft dispersible tablet comprising at least one drilling fluid additive and a softening agent; and
a drilling fluid for reverting the drilling fluid additive within the soft dispersible tablet into an original particle size distribution topside and transporting the drilling fluid additive within the drilling fluid.

2. The delivery system of claim 1 wherein
the drilling fluid additive is from around 95% to around 85% of the soft dispersible tablet; and
the softening agent is from around 5% to around 15% of the soft dispersible tablet.

3. The delivery system of claim 2 wherein the drilling fluid is a water based fluid.

4. The delivery system of claim 3 wherein the softening agent is selected from the group consisting of ethylene oxide adducts of phenol and nonyl phenol, a mixture of ethylene glycol and propylene glycol, high molecular weight water soluble polyethylene glycols, modified water dispersible lecithins, and combinations thereof.

5. The delivery system of claim 2 wherein the drilling fluid is a synthetic or diesel based fluid.

6. The delivery system of claim 5 wherein the softening agent is selected from the group consisting of sodium dodecyl benzene sulfonate, fatty acid amides and imidazolines of polyamines, phospholipids, and combinations thereof.

7. A method of delivering a drilling fluid additive to a drilling fluid, the method comprising the steps of:
supplying or preparing a drilling fluid additive;
mixing a softening agent with the drilling fluid additive;
tabletizing the drilling fluid additive and the softening agent to form a soft dispersible tablet; and
delivering the drilling fluid additive to the drilling fluid by dispersing the soft dispersible tablet into the drilling fluid thereby reverting the drilling fluid additive into an original particle size distribution.

8. The method of claim 7 wherein the step of reverting the drilling fluid additive into the original particle size distribution occurs topside.

9. The method of claim 8 wherein the step of tabletizing the drilling fluid additive and the softening binding to form a soft dispersible tablet results in the drilling fluid additive being from around 95% to around 85% of the soft dispersible tablet and the softening agent being from around 5% to around 15% of the soft dispersible tablet.

10. The method of claim 9 wherein the step of dispersing the soft dispersible tablet into a drilling fluid includes utilizing a water based fluid as the drilling fluid.

11. The method of claim 10 wherein the softening agent is selected from the group consisting of ethylene oxide adducts of phenol and nonyl phenol, a mixture of ethylene glycol and propylene glycol, high molecular weight water soluble polyethylene glycols, modified water soluble dispersible lecithins, and combinations thereof.

12. The method of claim 9 wherein the step of dispersing the soft dispersible tablet into the drilling fluid includes utilizing a synthetic or diesel based fluid as the drilling fluid.

13. The method of claim 12 wherein the softening agent is selected from the group consisting of sodium dodecyl benzene sulfonate, fatty acid amides and imidazolines of polyamines, and phospholipids.

14. A soft dispersible tablet for delivering drilling fluid additives in a drilling fluid comprising:
a softening agent; and
an untreated drilling fluid additive, said additive being compressed such that the density of the drilling fluid additive is substantially increased.

15. The soft dispersible tablet of claim 14 wherein the drilling fluid additive is from around 95% to around 85% of the soft dispersible tablet and the softening agent is from around 5% to around 15% of the soft dispersible tablet.

16. The soft dispersible tablet of claim 15 wherein the drilling fluid is a water based fluid.

17. The soft dispersible tablet of claim 16 wherein the softening agent is selected from the group consisting of ethylene oxide adducts of phenol and nonyl phenol, a mixture of ethylene glycol and propylene glycol, high molecular weight water soluble polyethylene glycols, and modified water dispersible lecithins.

18. The soft dispersible tablet of claim 15 wherein the drilling fluid is a synthetic or diesel based fluid.

19. The soft dispersible tablet of claim 18 wherein the softening agent is selected from the group consisting of sodium dodecyl benzene sulfonate, fatty acid amides and imidazolines of polyamines, and phospholipids.
